(19) United States
(12) Patent Application Publication
(10) Pub. No.: US 2007/0102659 A1
(43) Pub. Date: May 10, 2007

(54) Valve for controlling fluids with a multifunctional component

(76) Inventor: Andreas Schrade, Immenstadt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/578,356

(22) PCT Filed: Oct. 23, 2004
(86) PCT No.: PCT/DE04/02365

§ 371 Date: May 5, 2006

(30) Foreign Application Priority Data
Nov. 7, 2003 (DE) 103-52-003.1

(51) Int. Cl. F16K 31/02

(52) U.S. Cl. 251/129.02

(57) ABSTRACT

A valve for controlling fluids, including a closing element for closing and opening an opening, a restoring element for restoring the closing element to its outset position, a movably disposed armature which is movable by means of an armature coil, and a multifunctional component which includes the function of a valve body and the function of a throttle component in a single component.

### PRIOR ART

The present invention relates to an electromagnet valve for controlling fluids, in particular for hydraulic systems in vehicles. Various versions of such valves are known in the prior art. FIG. 2 shows one known electromagnet valve of the prior art. The valve 1 includes an armature 2, which is connected to an actuating element embodied as a tappet and can be moved in a known manner by means of a magnet coil 3. The armature 2 is movable inside a sleeve 4 in a known manner. The sleeve 4 is connected to a valve insert 11, which serves as a guide element for the actuating element 5. A restoring spring 6 returns the actuating element 5 to its outset position. The known valve further includes a valve body 12, in which an opening 14 that is to be closed and opened by the valve and a plastic insert 13 with a throttle restriction are located. To prevent the valve 1 from becoming soiled, two filters 9 and 10 are also provided. Via a check valve 8, any overpressure that may possibly occur in the valve is reversed. In the currentless state, the valve is constantly open.

A disadvantage of this valve is that the active part of the valve comprises a plurality of individual components, such as the valve insert 11, the valve body 12, and the plastic insert 123. This increases the number of parts needed and makes assembly complicated. Moreover, especially if plastic is used for the plastic insert 13, damage can occur as loads increase and over the course of the service life. This is highly important, since more recent and future hydraulic systems in vehicles operate at higher and higher pressures.

### ADVANTAGES OF THE INVENTION

The valve for controlling fluids according to the invention as defined by the characteristics of claim 1 has the advantage over the prior art that is can be produced especially economically and has only a small number of parts. As a result, the assembly costs for the valve can also be reduced, which has especially great cost advantages because valves are items that are mass-produced on a large scale. According to the invention, this is attained in that the valve has a multifunctional component, which integrates multiple components into itself and takes on their functions. In particular, the multifunctional component takes on the function of the valve insert for guiding the actuating element, the function of the valve body, in which the opening to be opened and closed is located, and the function of a throttle component. The multifunctional component can accordingly replace a plurality of individual components that were previously used in the valve.

Preferred refinements of the invention are shown by the dependent claims.

The multifunctional component also preferably includes a function for a check valve, by way of which an overpressure that may possibly be present can be reversed.

Especially preferably, the multifunctional component is produced by means of a powder metallurgy process. As a result, even difficult geometries of the multifunctional component can be produced in a simple way. Also as a result, high accuracy in adhering to tolerances can be attained. A valve produced by powder metallurgy processes is moreover capable of meeting even stringent demands in terms of the pressure load. This is not true of the valves used until now, since they still used components made of plastic, such as the throttle component.

As the powder metallurgy process, sintering or powder injection molding is preferably employed.

The valves according to the invention are preferably used in hydraulic systems of vehicles. Especially preferably, valves according to the invention are used in ABS systems and/or traction control systems and/or other drive regulation and brake systems of a vehicle.

### DRAWING

One exemplary embodiment of the invention is described below in detail in conjunction with the drawing. In the drawing:

FIG. 1 is a schematic sectional view of a valve for controlling fluids in a preferred exemplary embodiment of the invention; and

FIG. 2 is a schematic sectional view of a valve for controlling fluids in a preferred exemplary embodiment in the prior art.

### DESCRIPTION OF THE EXEMPLARY EMBODIMENT

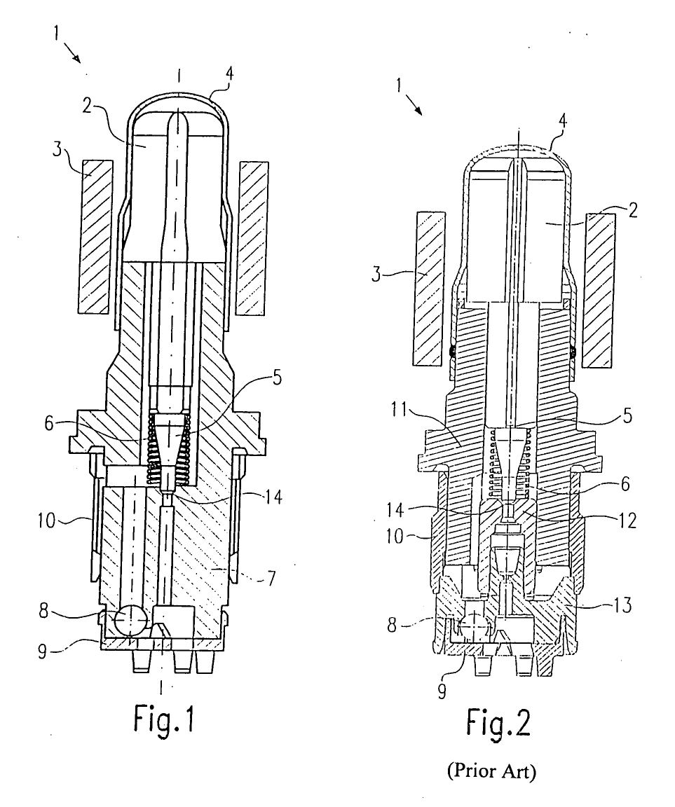

FIG. 1 shows a valve for controlling fluids in a preferred exemplary embodiment of the invention.

The valve 1 includes an armature 2, which can be moved back and forth in a sleeve 4 as a result of electric current being supplied to a magnet coil 3. The armature 2 is connected to an actuating element 6 in the form of a tappet, so that an opening 14 can be opened and closed. A restoring spring 6 furnishes restoration of the actuating element 5 and the armature 2 to their outset position. To prevent such contaminates as tiny metal chips or the like from getting into the valve 1, two filters 9 and 10 are also provided.

The valve 1 according to the invention further includes a multifunctional component 7. Multiple functions are integrated in the multifunctional component 7. More precisely, the function of a valve insert for guiding the actuating element 5, the function of a valve body, in which the opening 14 to be opened and closed is embodied, and the function of a throttle component are integrated in the multifunctional component. The multifunctional component further includes a springless check valve 8, by way of which any overpressure that may occur can be reversed.

In the currentless state, the restoring spring 6 presses the actuating element 5 constantly against the armature 2 and thus keeps the valve open. To close the valve, current is supplied to the magnet coil, causing the armature to be pressed against the back side of the actuating element 5, as a result of which the actuating element 5 moves axially, counter to the spring force of the restoring spring 6, and closes the opening 14.

The multifunctional component 7 of the magnet valve is produced by a powder metallurgy process and has a high load-bearing capacity, which is markedly higher than that of plastic parts. By the powder metallurgy production process, the requisite complex geometry of the throttle component can also be attained, while adhering to the necessary tolerance values. A multifunctional component 7 produced in this way moreover has increased tightness, since because of the reduced number of parts involved, there are fewer sealing faces between the individual components of the valve. Depending on the intended use of the valve, the most various metal alloys can be used.

The magnet valve 1 of the invention is preferably used as a 2/2-way magnet valve in the hydraulic system of an ABS system.

1-6. (canceled)

7. A valve for controlling fluids, comprising a closing element for closing and opening an opening, a restoring element for restoring the closing element to its outset position, a movably disposed armature which is movable by means of an armature coil, and a multifunctional component which includes the function of a valve body and the function of a throttle component in a single component.

8. The valve for controlling fluids in accordance with claim 7, wherein that the multifunctional component further comprises the function of a check valve.

9. The valve for controlling fluids in accordance with claim 7, wherein the multifunctional component is produced by means of powder metallurgy processes.

10. The valve for controlling fluids in accordance with claim 8, wherein the multifunctional component is produced by means of powder metallurgy processes.

11. The valve for controlling fluids in accordance with claim 9, wherein the multifunctional component is produced by means of sintering.

12. The valve for controlling fluids in accordance with claim 10, wherein the multifunctional component is produced by means of sintering.

13. The valve for controlling fluids in accordance with claim 7, wherein the valve is used in a hydraulic system in a vehicle.

14. The valve for controlling fluids in accordance with claim 8, wherein the valve is used in a hydraulic system in a vehicle.

15. The valve for controlling fluids in accordance with claim 9, wherein the valve is used in a hydraulic system in a vehicle.

16. The valve for controlling fluids in accordance with claim 10, wherein the valve is used in a hydraulic system in a vehicle.

17. The valve for controlling fluids in accordance with claim 11, wherein the valve is used in a hydraulic system in a vehicle.

18. The valve for controlling fluids in accordance with claim 12, wherein the valve is used in a hydraulic system in a vehicle.

19. The valve for controlling fluids in accordance with claim 13, wherein the valve is used in a brake system and/or an electronic stability system and/or a traction control system.

20. The valve for controlling fluids in accordance with claim 14, wherein the valve is used in a brake system and/or an electronic stability system and/or a traction control system.

21. The valve for controlling fluids in accordance with claim 15, wherein the valve is used in a brake system and/or an electronic stability system and/or a traction control system.

22. The valve for controlling fluids in accordance with claim 16, wherein the valve is used in a brake system and/or an electronic stability system and/or a traction control system.

23. The valve for controlling fluids in accordance with claim 17, wherein the valve is used in a brake system and/or an electronic stability system and/or a traction control system.

24. The valve for controlling fluids in accordance with claim 18, wherein the valve is used in a brake system and/or an electronic stability system and/or a traction control system.
